(19) United States
(12) Patent Application Publication
(10) Pub. No.: US 2023/0234604 A1
(43) Pub. Date: Jul. 27, 2023

(54) DRIVING ASSISTANCE APPARATUS, METHOD, AND NON-TRANSITORY STORAGE MEDIUM

(71) Applicant: TOYOTA JIDOSHA KABUSHIKI KAISHA, Toyota-shi (JP)

(72) Inventors: Van Quy Hung NGUYEN, Shizuoka-ken (JP); Shouji ITOU, MIshima-shi (JP); Akira HATTORI, Shizuoka-ken (JP)

(21) Appl. No.: 18/062,058

(22) Filed: Dec. 6, 2022

(30) Foreign Application Priority Data
Jan. 26, 2022 (JP) 2022-009783

(51) Int. Cl. B60W 50/16; B60W 30/095; B60W 40/08

(52) U.S. Cl. CPC B60W 50/16; B60W 30/0956; B60W 40/08; B60W 2554/80

(57) ABSTRACT

A driving assistance apparatus of a vehicle includes a processor configured to calculate a risk sensitivity index on risk avoidance of a driver of the vehicle with respect to a target existing around the vehicle, diagnose a change in the calculated risk sensitivity index, and notify the driver of information on the diagnosed change in the risk sensitivity index.

### CROSS-REFERENCE TO RELATED APPLICATION

This application claims priority to Japanese Patent Application No. 2022-009783 filed on Jan. 26, 2022, incorporated herein by reference in its entirety.

### BACKGROUND

### 1. Technical Field

The present disclosure relates to a driving assistance apparatus, a method, and a non-transitory storage medium.

### 2. Description of Related Art

Japanese Unexamined Patent Application Publication No. 2015-130069 discloses a driving assistance apparatus that decides, according to a lateral distance and an allowance that are based on a driving operation tendency of a driver of a vehicle, a timing at which assistance for avoiding a collision between a vehicle and a target existing in front of the vehicle is executed.

### SUMMARY

When a driving assistance technology is highly advanced and controls assistance without giving a driver a sense of discomfort in everyday driving, it may be difficult to distinguish whether a main reason that the vehicle can safely travel is based on a driving operation of the driver or based on an operation of a driving assistance function.

However, regardless of which is the main reason that the vehicle can safely travel, from a perspective of helping to improve driver's awareness of safe driving, it is desirable for the driver to be able to grasp a driving characteristic (for example, a situation where the safe driving is being executed or a change in the driving tendency), which is the driving operation tendency of the driver himself/herself at any time.

The present disclosure provides a driving assistance apparatus and the like that enables a driver who drives a vehicle to grasp a driving characteristic, which is a driving operation tendency of a driver himself/herself.

A first aspect of the present disclosure is a driving assistance apparatus of a vehicle. The driving assistance apparatus includes a processor configured to calculate a risk sensitivity index on risk avoidance of a driver of the vehicle with respect to a target existing around the vehicle, diagnose a change in the calculated risk sensitivity index, and notify the driver of information on the diagnosed change in the risk sensitivity index.

A second aspect of the present disclosure is a method executed by a computer of a driving assistance apparatus of a vehicle. The method includes calculating a risk sensitivity index on risk avoidance of a driver of the vehicle with respect to a target existing around the vehicle, diagnosing a change in the risk sensitivity index, and notifying the driver of information on the diagnosed change in the risk sensitivity index.

A third aspect of the present disclosure is a non-transitory storage medium storing instructions that are executable by a processor of a driving assistance apparatus of a vehicle and that cause the processor to execute functions. The functions include calculating a risk sensitivity index on risk avoidance of a driver of the vehicle with respect to a target existing around the vehicle, diagnosing a change in the risk sensitivity index, and notifying the driver of information on the diagnosed change in the risk sensitivity index.

With each aspect of the present disclosure, a driver who drives a vehicle can grasp a driving characteristic, which is a driving operation tendency of the driver himself/herself, through information on a change in a risk sensitivity index.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle system including a driving assistance apparatus according to the present embodiment;

FIG. 2 is a flowchart of data collection learning processing executed by the driving assistance apparatus;

FIG. 3A is a diagram illustrating an example of a relationship between a distance and speed between a subject vehicle and a preceding vehicle;

FIG. 3B is a diagram illustrating an example of a relationship between a distance and speed between a vehicle and a pedestrian;

FIG. 4 is a correlation image diagram between a risk sensitivity index and a safety tendency;

FIG. 5 is a flowchart of driving assistance processing executed by the driving assistance apparatus; and

FIG. 6 is an example of the content of driving assistance based on the risk sensitivity index.

### DETAILED DESCRIPTION OF EMBODIMENTS

A driving assistance apparatus of the present disclosure collects traveling data on a vehicle and a target while the vehicle is traveling, and learns, using the collected data, a driving sense of an individual driver who drives the vehicle. Then, the driving assistance apparatus gives the driver feedback on a change in a driving characteristic on risk avoidance of the driver, which is calculated based on the collected traveling data and the learned driving sense of the individual driver. As such, the driver of the vehicle can grasp his/her driving operation tendency for safe driving. Hereinafter, embodiments of the present disclosure will be described in detail with reference to the drawings.

### Embodiment

Configuration

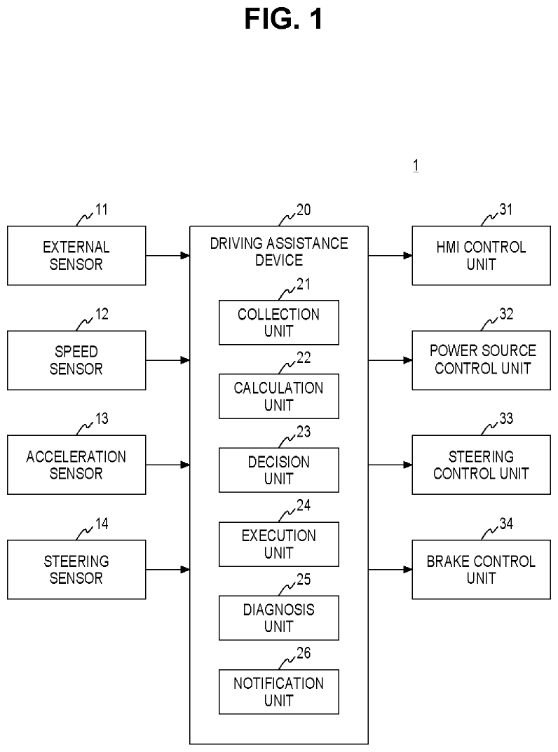

FIG. 1 is a diagram illustrating a schematic configuration of a vehicle system 1 including a driving assistance apparatus 20 according to an embodiment of the present disclosure. The vehicle system 1 exemplified in FIG. 1 includes an external sensor 11, a speed sensor 12, an acceleration sensor 13, a steering angle sensor 14, a driving assistance apparatus 20, an HMI control unit 31, a power source control unit 32, a steering control unit 33, and a brake control unit 34. The vehicle system 1 can be mounted on a vehicle, such as a hybrid electric vehicle or a battery electric vehicle.

The external sensor 11 is a sensor used for detecting/acquiring information on the external environment of the vehicle. Specifically, the external sensor 11 is installed in, for example, a front side or a rear side of the vehicle, detects a target, such as a preceding vehicle or a two-wheeled vehicle existing in front of the vehicle mainly around the vehicle, and acquires information (for example, a type, speed, and a distance) of the detected target. The external sensor 11 can be, for example, a radar sensor using laser, millimeter waves, microwaves, or ultrasonic waves, or a camera sensor using a charge coupled device (CCD) or a complementary metal oxide semiconductor (CMOS). The information on the external environment of the vehicle (for example, the information on the target) detected/acquired in the external sensor 11 is output to the driving assistance apparatus 20.

The speed sensor 12 is a sensor used for detecting/acquiring speed of the vehicle. The speed sensor 12 can be, for example, a wheel speed sensor installed in each wheel of the vehicle and used for detecting a rotational speed (or a rotation amount) of the wheel. The speed of the vehicle detected/acquired in the speed sensor 12 is output to the driving assistance apparatus 20 as the information on the vehicle.

The acceleration sensor 13 is a sensor used for detecting/acquiring the magnitude of acceleration G applied to the vehicle. The acceleration sensor 13 can be a three-axis accelerometer installed in a predetermined location of the vehicle and detecting acceleration in, for example, the vehicle front-rear direction, the vehicle width direction, and the vehicle up-down direction. The information on the acceleration detected/acquired in the acceleration sensor 13 is output to the driving assistance apparatus 20 as the information on the vehicle.

The steering angle sensor 14 is a sensor used for detecting/acquiring a steering angle of a steering wheel according to a steering operation of the driver of the vehicle. The steering angle sensor 14 is installed in, for example, a steering control unit 33 of the vehicle. The information on the steering angle of the steering wheel detected/acquired in the steering angle sensor 14 is output to the driving assistance apparatus 20 as the information on the vehicle.

A human machine interface (HMI) control unit 31 is capable of controlling, according to an instruction output from the driving assistance apparatus 20, presentation, to the driver who drives the vehicle, of information, such as an operation state of driving assistance or a driving characteristic, which is the driving operation tendency of the driver. For the information presentation, various devices (not shown), such as a head-up display (HUD), a navigation system monitor, a meter panel, and a speaker, are used.

The power source control unit 32 is capable of controlling, according to an instruction output from the driving assistance apparatus 20, an actuator (not shown) serving as a power source of the vehicle, such as an internal combustion engine or a traveling motor, and controlling a driving force or a braking force generated in each of these power sources.

The steering control unit 33 is capable of controlling, according to an instruction output from the driving assistance apparatus 20, a force that assists the steering of the vehicle by, for example, an electric power steering mechanism (not shown).

The brake control unit 34 is capable of controlling, according to an instruction output from the driving assistance apparatus 20, a braking force generated on the wheels through a brake device of the vehicle by, for example, an electric brake mechanism (not shown).

The driving assistance apparatus 20 executes a control instruction on the HMI control unit 31, the power source control unit 32, the steering control unit 33, and the brake control unit 34, and executes the driving assistance suitable for the driver who drives the vehicle, based on the information on the vehicle or the information on the external environment (for example, the information on the target) on the vehicle obtained from, for example, the external sensor 11, the speed sensor 12, the acceleration sensor 13, and the steering angle sensor 14. Further, the driving assistance apparatus 20 also sends, to the driver, a notification on a feedback (F/B) on the driving characteristic of the driver who drives the vehicle.

The driving assistance apparatus 20 can be configured as a part or all of an electronic control unit (ECU) that typically includes, for example, a processor, a memory, and an input/output interface. The driving assistance apparatus 20 of the present embodiment realizes each function of a collection unit 21, a calculation unit 22, a decision unit 23, an execution unit 24, a diagnosis unit 25, and a notification unit 26 that are described below when the processor reads out and executes a program stored in the memory.

The collection unit 21 collects vehicle traveling data including the information on the vehicle necessary for the driving assistance and the information on the external environment (for example, the information on the target) of the vehicle, from the external sensor 11, the speed sensor 12, the acceleration sensor 13, the steering angle sensor 14, and the like. The calculation unit 22 learns the content of the driving operation (the driving tendency, the driving sense) executed by the driver who drives the vehicle, and calculates a risk sensitivity index (RSI) on the risk avoidance of the driver, which reflects a result of the learning. The decision unit 23 decides the content of the driving assistance (a driving assistance method) suitable for the driver who drives the vehicle, based on the risk sensitivity index RSI calculated by the calculation unit 22. The content of the decided driving assistance is the content suitable for the sense of the driver. The execution unit 24 assists the driving operation of the driver who drives the vehicle according to the content of the driving assistance decided by the decision unit 23. The diagnosis unit 25 diagnoses a change in the risk sensitivity index RSI calculated by the calculation unit 22. The notification unit 26 sends, to the driver, a notification of information on the change in the risk sensitivity index RSI which is diagnosed by the diagnosis unit 25. Details of the above-described vehicle traveling data, the risk sensitivity index RSI, the method of deciding the content of the driving assistance, the method of diagnosing the change in the risk sensitivity index RSI, and the method of sending a notification of the information on the change in the risk sensitivity index RSI will be described below.

Control

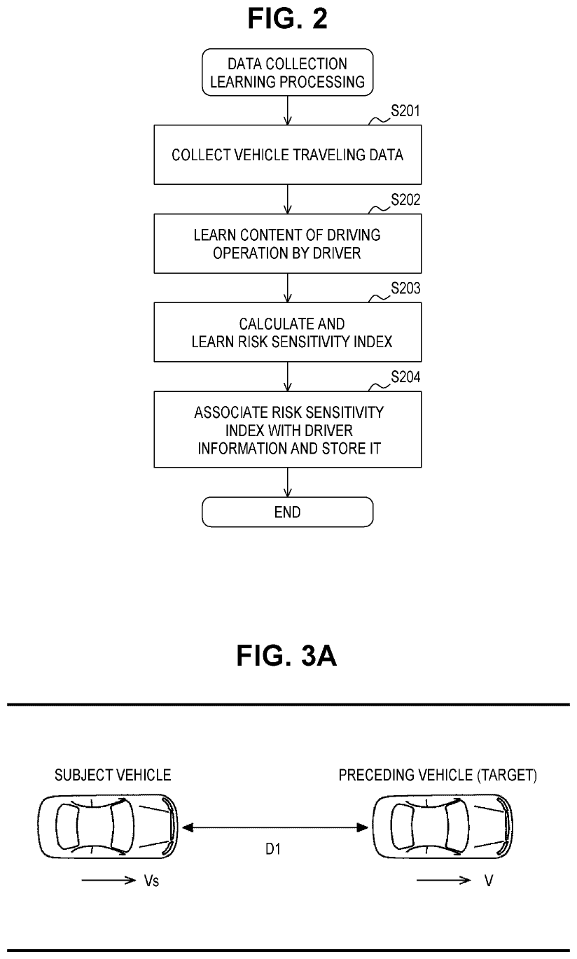

Next, processing executed by the driving assistance apparatus 20 according to the present embodiment will be described with further reference to FIGS. 2 to 6. The processing executed by the driving assistance apparatus 20 includes data collection learning processing and driving assistance processing.

(1) Data Collection Learning Processing

FIG. 2 is a flowchart describing procedures of the data collection learning processing executed by the collection unit 21 and the calculation unit 22 of the driving assistance apparatus 20. The data collection learning processing exemplified in FIG. 2 is executed when, for example, an ignition of the vehicle is turned on (IG-ON) and a trip is started.

(Step S201) As an example, the collection unit 21 of the driving assistance apparatus 20 collects, for example, the vehicle traveling data when (at a time of target approaching) the vehicle approaches a target, such as a preceding vehicle, and the driver starts decelerating, or the vehicle traveling data when (at a time of target overtaking) the vehicle overtakes the target, such as a pedestrian or a bicycle. Decelerating is an action taken by the driver who drives the vehicle when the driver stops shortening of a distance between the vehicle and the preceding vehicle, and includes an action, such as depressing a brake pedal, taking off his/her foot from an accelerator pedal, or lowing a gear and applying an engine brake. Further, overtaking can include actions by the vehicle, ranging from approaching the target by a first distance thereto, overtaking the target by a distance of a second distance or longer therefrom, to moving away from the target by a third distance after overtaking. The collected vehicle traveling data includes at least a vehicle speed Vs, a relative speed of the target Vr (for example, the preceding vehicle, the pedestrian, or a bicycle) seen from the vehicle, a relative acceleration/deceleration of the target Ar seen from the vehicle, a front-rear direction distance D₁ between the vehicle and the target, and a lateral direction distance D₂ between the vehicle and the target.

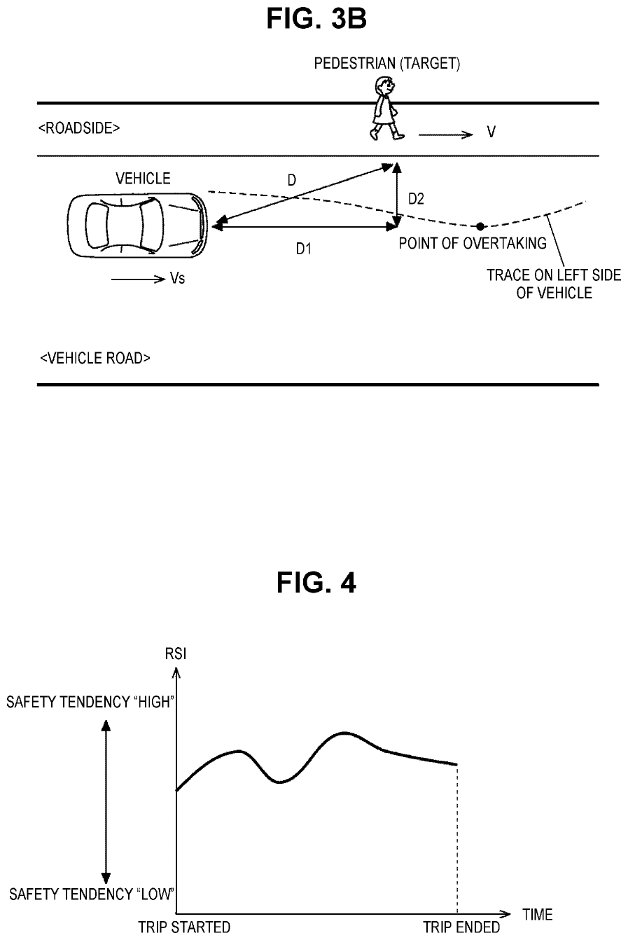

FIG. 3A is a diagram illustrating an example of a relationship between a distance and a speed between a subject vehicle traveling on a road and a preceding vehicle (a target) moving in the same direction as the subject vehicle. The vehicle traveling data may be, for example, data of an instantaneous value when the vehicle starts decelerating, or may be the average value of a predetermined period from the time when the vehicle starts decelerating.

FIG. 3B is a diagram illustrating an example of a relationship between a distance and a speed between a vehicle traveling on the road and a pedestrian (a target) moving along a roadside in the same direction as the vehicle. A timing or the number of times of collecting the traveling data may be, for example, a plurality of number of times at predetermined intervals (for example, fixed time intervals, or fixed distance intervals) in a period from when the vehicle approaches the target by the first distance (the front-rear direction distance D₁ or the relative distance D) and overtakes the target, to when the vehicle moves away from the target by the third distance (the front-rear direction distance D₁ or the relative distance D).

When the collection unit 21 collects the vehicle traveling data at the time of the target approaching, the vehicle traveling data at the time of the target overtaking, or the like, the process proceeds to step S202.

(Step S202) The calculation unit 22 of the driving assistance apparatus 20 learns the content (the driving tendency, the driving sense) of the driving operation executed by the driver who drives the vehicle, using the vehicle traveling data at the time of the target approaching or at the time of the target overtaking, collected by the collection unit 21. The calculation unit 22 of the present embodiment learns each of the driver's sense of speed on a movement in the front-rear direction h (or a), the driver's sense of speed on a movement in the lateral direction k, the driver's sense of acceleration/deceleration β, the driver's sense of a prediction of a front-rear direction distance m, and the driver's sense of a prediction of a lateral distance n. It can be said that the driver's sense of speed h (or a) is a parameter expressing a discrepancy between the driver's sense of speed in the vehicle front-rear direction and the actual speed. It can be said that the driver's sense of speed k is a parameter expressing a discrepancy between the driver's sense of speed in the vehicle lateral direction and the actual speed. It can be said that the driver's sense of acceleration/deceleration β is a parameter expressing a discrepancy between the driver's sense of relative acceleration/deceleration between the vehicle and the target and the actual relative acceleration/deceleration. It can be said that the driver's sense of the prediction of the front-rear direction distance m is a parameter expressing a discrepancy between the driver's estimation of a distance between the vehicle and the target in the front-rear direction and the actual distance. It can be said that the driver's sense of the prediction of the lateral direction distance n is a parameter expressing a discrepancy between the driver's estimation of a distance between the vehicle and the target in the lateral direction and the actual distance.

Each parameter of the driver's senses of speed h (or α), β, k, m, and n is obtained, as a parameter of the individual driver who drives the vehicle, based on, for example, a correlation between an inter-vehicle distance and time to collision (TTC), a correlation between the inter-vehicle distance and the relative speed, a correlation between the inter-vehicle distance and the speed and the timing of starting the brake, and the risk avoidance sensitivity index (iPRE), which is obtained by quantifying the characteristic of the driving operation that the driver can acquire in order to avoid a contact with the target, which is an object having a risk of colliding with the vehicle when the vehicle approaches and passes by the target. These correlations can be obtained by, for example, being measured by experimental traveling of, a test driver or the like, or being estimated by executing a simulation.

The calculation unit 22 updates, as a learned value, each value of the new driver's senses of speed h (or α), β, k, m, and n, which is obtained using the vehicle traveling data collected in step S201 at the time of the target approaching or the target overtaking. When each value of the driver's senses of speed h (or α), β, k, m, and n, which are the content of the driving operation of the driver, is learned by the calculation unit 22, the process proceeds to step S203.

(Step S203) The calculation unit 22 of the driving assistance apparatus 20 calculates the risk sensitivity index RSI based on a driver's sense (a vehicle's sense) of proximity in the front-rear direction according to the following first formula, using the vehicle traveling data at the time of target approaching collected in step S201 and, for example, the value of the driver's sense of speed a, the value of the driver's sense of acceleration/deceleration β, and the value of the driver's sense of the prediction in the front-rear direction distance m that are learned and updated in step S202. The driver's sense of proximity in the front-rear direction is on the driver's sense of the front-rear direction distance to the target that the driver is approaching or overtaking.

$$\begin{matrix}[ Formula 1 ] & \\ R S I = \frac{Vr + α Vs + β Ar}{{D}_{1}^{m}} … & Equation ( 1 )\end{matrix}$$

Alternatively, the calculation unit 22 of the driving assistance apparatus 20 calculates the risk sensitivity index RSI based on the driver's senses (the vehicle's senses) of proximity in the front-rear direction and the lateral direction according to the following second formula in consideration of a weighted parameter θ₁ of a risk sensitivity in the front-rear direction and a weighted parameter θ₂ of a risk sensitivity in the lateral direction that are set in advance for each driver, using the vehicle traveling data at the time of the target overtaking collected in step S201, and the values of the driver's senses of speed h and k, the value of the driver's sense of the prediction in the front-rear direction distance m, and the value of the driver's sense of the prediction in the lateral direction distance n that are learned and updated in step S202. The driver's sense of proximity in the front-rear direction is as described above, and the driver's sense of proximity in the lateral direction is on the driver's sense of the lateral direction distance to the target that the driver is approaching or overtaking.

$$\begin{matrix}[ Formula 2 ] & \\ R S I = {θ}_{1} \frac{h \times Vs + Vr}{{D}_{1}^{m}} + {θ}_{2} \frac{k \times Vs + Vr}{{D}_{2}^{n}} & Equation ( 2 )\end{matrix}$$

The risk sensitivity index RSI is frequently calculated during one trip from a time when the ignition of the vehicle is turned on (IG-ON) to a time when the ignition is turned off (IG-OFF). Then, based on statistical values of a plurality of risk sensitivity indices RSI calculated in one trip, the driving operation tendency (safety tendency) on the safety of the individual driver is learned. FIG. 4 illustrates a correlation image between the risk sensitivity index RSI calculated in one trip and the safety tendency. In the risk sensitivity index RSI in the present embodiment, the safety tendency of the driver is increased as the numerical value of the RSI becomes higher. When the risk sensitivity index RSI is calculated and learned by the calculation unit 22, the process proceeds to step S204.

(Step S204) The calculation unit 22 of the driving assistance apparatus 20 associates the risk sensitivity index RSI newly calculated and learned in step S203 with information on the driver who drives the vehicle, and stores it in, for example, a predetermined memory included in the driving assistance apparatus 20. The identity of the individual driver who drives the vehicle can be specified by using a well-known determination method, such as a determination by a unique ID of the electronic key held by the driver, a determination by an adjusted driving (seat) position, or a determination by image analysis using a driver's camera. When the calculation unit 22 associates the risk sensitivity index RSI with the information on the driver with which an individual can be specified, and stores it, the data collection learning processing ends.

(2) Driving Assistance Processing

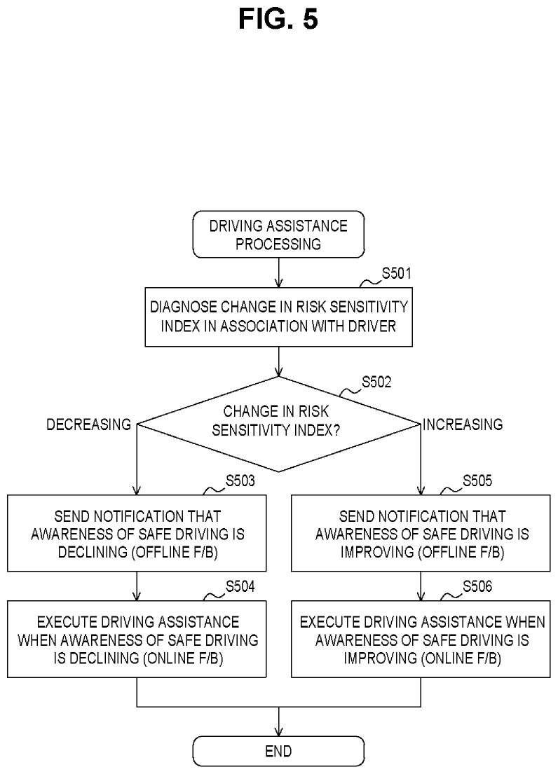

FIG. 5 is a flowchart describing procedures of the driving assistance processing executed by the decision unit 23, the execution unit 24, the diagnosis unit 25, and the notification unit 26 of the driving assistance apparatus 20. The driving assistance processing exemplified in FIG. 5 is executed when, for example, the ignition of the vehicle is turned on (IG-ON) and a trip is started.

(Step S501) The diagnosis unit 25 of the driving assistance apparatus 20 acquires, from the predetermined memory or the like, the risk sensitivity indices RSI, which are associated with the information on the driver who drives the vehicle and stored, and diagnoses a change in the risk sensitivity index RSI of the driver based on the acquired plurality of risk sensitivity indices that have been stored so far. The individual driver who drives the vehicle is specified as described above.

The risk sensitivity index RSI can be changed on, for example, a daily, weekly, and monthly basis. For example, a change on a daily basis can be a change in the risk sensitivity index RSI (for example, the average value, the maximum value, and the minimum value,) calculated and learned during yesterday's trip with respect to the risk sensitivity index RSI calculated and learned in a trip the day before yesterday. Further, the change to be diagnosed may be an absolute change with respect to the risk sensitivity indices RSI of other drivers (for example, the national average), in addition to a relative change based on past risk sensitivity indices RSI of the driver himself/herself. The diagnosis of a change can be separately diagnosed on each of a change in the sense in the vehicle front-rear direction (the intra-vehicle distance), a change in the sense in the vehicle lateral direction, a change in the sense of speed, and the like, based on each parameter used in, for example, the calculation of the risk sensitivity index RSI, in addition to a method of comprehensively executing the diagnosis of a change only by the risk sensitivity index RSI. Further, a speed adjustment ability, a reaction ability, or the like may be diagnosed based on each parameter. When the diagnosis of a change in the risk sensitivity index RSI, which is associated with the driver who drives the vehicle, is executed, the process proceeds to step S502.

(Step S502) The diagnosis unit 25 of the driving assistance apparatus 20 determines the change in the risk sensitivity index RSI diagnosed in step S501. Specifically, the diagnosis unit 25 determines whether the risk sensitivity index RSI is changing in a decreasing direction. When the risk sensitivity index RSI is changing in the decreasing direction (decreasing in step S502), it is assumed that the driver's awareness of the safe driving is declining, and the process proceeds to step S503. On the other hand, when the risk sensitivity index RSI is not changing in the decreasing direction (increasing in step S502), it is assumed that the driver's awareness of the safe driving is improving, and the process proceeds to step S505.

(Step S503) The notification unit 26 of the driving assistance apparatus 20 sends, to the driver who drives the vehicle, a notification (assistance by offline F/B) that the driver's awareness of the safe driving is declining. As an example of the notification when the driver's safety awareness is declining, there is a method of providing a risk sensitivity index RSI having a particularly low numerical value in various scenes in which the driver has driven so far, via a predetermined display or the like. The risk sensitivity index RSI may be provided together with captured images of a drive recorder or the like in those scenes. Further, as another example of the notification, there is a method of providing an image of an accident scene that the driver is highly likely to encounter in the future, which is predicted from the risk sensitivity index RSI having a low numerical value, via a predetermined display or the like. An image, text, a figure, and the like that are prepared in advance can be used in the accident scene. Further, as yet another example of the notification, there is a method of providing a change in the driving characteristic of the driver, which is determined from the risk sensitivity indices RSI so far, via a predetermined display or the like. The change in the driving characteristic may indicate that the driving tendency or a risk perception performance is lower than before, using a vector display corresponding to the vehicle front-rear direction and the vehicle lateral direction, or the like. When the notification unit 26 sends a notification that the driver's awareness of the safe driving is declining, the process proceeds to step S504.

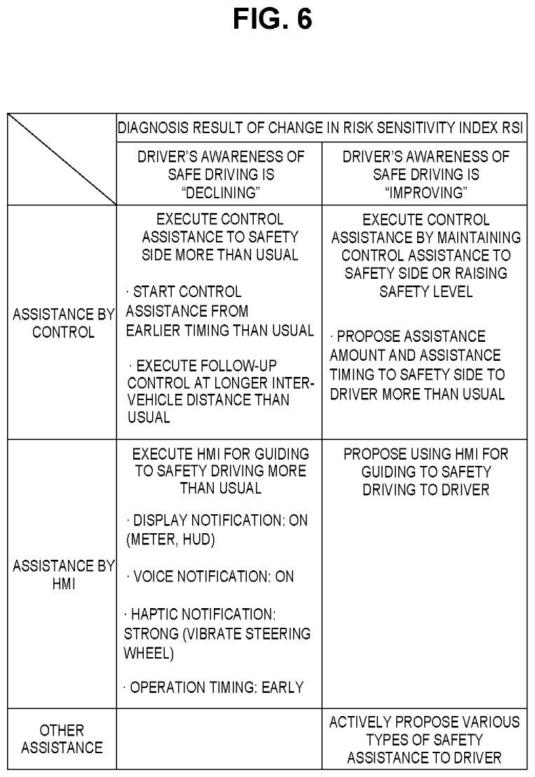

(Step S504) When the driver's awareness of the safe driving is declining, the decision unit 23 and the execution unit 24 of the driving assistance apparatus 20 execute the driving assistance (assistance by online F/B) on the driver who drives the vehicle. As an example of the driving assistance when the safety awareness is declining, there is a method of providing information, such as “Isn't the intra-vehicle distance a little short today?” or “Isn't your inter-vehicle distance a little shorter than those of the surrounding drivers?” via a predetermined application or a display. Further, the decision unit 23 and the execution unit 24 execute the driving assistance by a control/HMI on a driver whose awareness of the safe driving is declining. The content of the driving assistance by the control/HMI executed on the driver whose safety awareness is declining is exemplified in a left column of FIG. 6.

In the present embodiment, when the driver's awareness of the safe driving is declining, the assistance for controlling the vehicle to the safety side is executed while ensuring greater safety than usual. More specifically, for example, as compared with a standard (default) setting, the assistance for controlling is started at an earlier timing than usual or a follow-up controlling is executed at a longer inter-vehicle distance than usual.

Further, when the driver's awareness of the safe driving is declining, the assistance for guiding the driver to the safe driving is executed by the HMI with more emphasis on the guidance than usual. A typical assistance by the HMI in this case is realized by, for example, controlling turning on, using the HMI control unit 31, a display notification via a meter panel, a head-up display (HUD), or the like, and a voice notification via a speaker or the like, strongly controlling a haptic notification by vibrating the steering wheel using the steering control unit 33, and controlling the operation timing early.

In the case where the driving assistance has been executed on the driver when the driver's awareness of the safe driving is declining, the driving assistance processing ends.

(Step S505) The notification unit 26 of the driving assistance apparatus 20 sends, to the driver who drives the vehicle, a notification (assistance by offline F/B) that the driver's awareness of the safe driving is improving. As an example of the notification when the driver's safe awareness is improving, there is a method of providing a risk sensitivity index RSI having a particularly high numerical value in various scenes in which the driver has driven so far, via a predetermined display or the like. The risk sensitivity index RSI may be provided together with a captured image of a drive recorder or the like in that scene. Further, as another example of the notification, there is a method of providing an accident scene that the driver is highly likely to encounter in the future as predicted from the risk sensitivity index RSI having a low numerical value, via a predetermined display or the like. An image, text, a figure, and the like that are prepared in advance can be used in the accident scene. When the safety awareness is improving, it is desirable that the number of accident scenes provided to the driver is smaller than when the safety awareness is declining. Further, as yet another example of the notification, there is a method of providing a change in the driving characteristic of the driver, which is determined from the risk sensitivity indices RSI so far, via a predetermined display or the like. The change in the driving characteristic may indicate that the driving tendency or a risk perception performance is higher than before, using a vector display corresponding to the vehicle front-rear direction and the vehicle lateral direction, or the like. When the notification unit 26 sends a notification that the driver's awareness of the safe driving is improving, the process proceeds to step S506.

(Step S506) When the driver's awareness of the safe driving is improving, the decision unit 23 and the execution unit 24 of the driving assistance apparatus 20 execute the driving assistance (assistance by online F/B) on the driver who drives the vehicle. As an example of the driving assistance when the safety awareness is improving, there is a method of providing information, such as “You're driving at a safe intra-vehicle distance!”, “You're driving at a safe speed. It's good!”, or “You're decelerating early. It's good!” via a predetermined application or a display. Further, the decision unit 23 and the execution unit 24 execute the driving assistance by the control/HMI on a driver whose awareness of the safe driving is improving. The content of the driving assistance by the control/HMI executed on the driver whose safety awareness is improving is exemplified in a right column of FIG. 6.

In the present embodiment, when the driver's awareness of the safe driving is improving, the assistance for controlling the vehicle to the safety side is executed while maintaining the current safety level or making the safety level higher than the current safety level. More specifically, for example, it is possible to propose an amount and a timing of assistance for guiding the driver to the safety side more than usual to the driver who drives the vehicle.

Further, when the driver's awareness of the safe driving is improving, it is possible to propose the use of assistance by the HMI for guiding the driver to the safe driving to the driver who drives the vehicle.

Further, in addition to the above-described assistance by the HMI, when the driver's awareness of the safe driving is improving, a control can be executed to actively propose various types of assistance on safety to the driver of the vehicle.

In the case where the driving assistance has been executed on the driver when the driver's awareness of the safe driving is improving, the driving assistance processing ends.

By the data collection learning processing (steps S201 to S204) and the driving assistance processing (steps S501 to S506) described above, it is possible to enable the driver who drives the vehicle to understand the safe driving, and to realize the execution of the driving assistance using the suitable content in which safety is prioritized according to the driver's driving characteristics.

In addition, in the present embodiment, an example where the state of the driver's awareness of the safe driving is divided, based on the change in the risk sensitivity index RSI, into two cases, that is, a case where it is declining and a case where it is improving has been described. However, in addition to this example with the above division, the state of the driver's awareness of the safe driving may be divided into three or more cases based on, for example, differences in the driver's driving types obtained by learning the driver's senses or the like.

Action and Advantageous Effect

As described above, with the driving assistance apparatus according to the embodiment of the present disclosure, the distance between the vehicle and the target in the front-rear direction and the lateral direction, the speed of the vehicle, the relative speed of the target seen from the vehicle, the relative acceleration/deceleration of the target seen from the vehicle are collected during the trip of the vehicle. Then, using the collected data, each parameter, such as the driver's sense of speed, the driver's sense of acceleration/deceleration, and the driver's sense of the prediction of the vehicle front-rear direction distance and the vehicle lateral direction distance, is learned. Then, based on the collected vehicle traveling data and each parameter obtained by learning, a risk sensitivity index on the risk avoidance of the driver who drives the vehicle is calculated, and the notification on the change in the risk sensitivity index is sent to the driver.

With the notification, the driver who drives the vehicle can easily know whether his/her the awareness of the safe driving has improved or decreased, and can grasp the driving characteristic, which is the driving operation tendency of the driver himself/herself.

As above, an embodiment of the present disclosure has been described above. However, the present disclosure can be regarded as a driving assistance apparatus, a method of executed by the driving assistance apparatus including a processor and a memory, a control program for executing the method, a computer-readable non-transitory storage medium storing the control program, and a vehicle having the driving assistance apparatus mounted thereon.

The driving assistance apparatus and the like of the present disclosure can be used in a vehicle and the like, and are useful when providing suitable driving assistance according to the driving characteristic of the driver who drives the vehicle.

What is claimed is:

1. A driving assistance apparatus of a vehicle, the driving assistance apparatus comprising a processor configured to:
calculate a risk sensitivity index on risk avoidance of a driver of the vehicle with respect to a target existing around the vehicle;
diagnose a change in the calculated risk sensitivity index; and
notify the driver of information on the diagnosed change in the risk sensitivity index.

2. The driving assistance apparatus according to claim 1, wherein the risk sensitivity index is a value based on at least one of a sense of proximity to the target of the vehicle in a vehicle front-rear direction and a sense of proximity to the target of the vehicle in a vehicle lateral direction.

3. The driving assistance apparatus according to claim 2, wherein the processor is configured to:
calculate the sense of proximity in the vehicle front-rear direction based on a speed of the vehicle, a relative speed between the vehicle and the target, a distance between the vehicle and the target in a front-rear direction, a driver's sense of the speed of the vehicle, and a driver's sense of the distance in the front-rear direction; and
calculate the sense of proximity in the vehicle lateral direction based on the speed of the vehicle, the relative speed between the vehicle and the target, a distance between the vehicle and the target in a lateral direction, the driver's sense of the speed of the vehicle, and a driver's sense of the distance in the lateral direction.

4. The driving assistance apparatus according to claim 3, wherein a value learned during actual traveling of the vehicle is used in the driver's senses.

5. The driving assistance apparatus according to claim 1, wherein the processor is configured to:
execute driving assistance based on the information on the change in the risk sensitivity index; and
change, when the processor diagnoses the change in the risk sensitivity index as a decrease, the driving assistance in a direction toward making the vehicle safer than before the change in the risk sensitivity index as the decrease.

6. The driving assistance apparatus according to claim 1, wherein the processor is configured to:
execute driving assistance based on the information on the change in the risk sensitivity index; and
when the processor diagnoses the change in the risk sensitivity index as an increase, maintain the driving assistance at a time of diagnosing the increase in the risk sensitivity index or make a level of the driving assistance higher than the level of the driving assistance at the time of the diagnosing the increase in the risk sensitivity index.

7. The driving assistance apparatus according to claim 5, wherein the processor is configured to, when the processor diagnoses the change in the risk sensitivity index as an increase, maintain the driving assistance at a time of diagnosing the change in the risk sensitivity index as the increase or make a level of the driving assistance higher than the level of the driving assistance at the time of diagnosing the change in the risk sensitivity index as the increase.

8. A method executed by a computer of a driving assistance apparatus of a vehicle, the method comprising:
calculating a risk sensitivity index on risk avoidance of a driver of the vehicle with respect to a target existing around the vehicle;
diagnosing a change in the risk sensitivity index; and
notifying the driver of information on the diagnosed change in the risk sensitivity index.

9. A non-transitory storage medium storing instructions that are executable by a processor of a driving assistance apparatus of a vehicle and that cause the processor to execute functions comprising:
calculating a risk sensitivity index on risk avoidance of a driver of the vehicle with respect to a target existing around the vehicle;
diagnosing a change in the risk sensitivity index; and
notifying the driver of information on the diagnosed change in the risk sensitivity index.
